(19) United States
(12) Patent Application Publication
(10) Pub. No.: US 2026/0138635 A1
(43) Pub. Date: May 21, 2026

(54) INTERFACE APPARATUS, INTERFACE METHOD, AND STORAGE MEDIUM

(71) Applicant: HONDA MOTOR CO., LTD., Tokyo (JP)

(72) Inventors: Toshihiro Hashimoto, Wako-shi (JP); Tsuyoshi Nojiri, Wako-shi (JP); Tatsuya Iwasa, Wako-shi (JP); Yuichiro Shimura, Wako-shi (JP); Haruko Okuyama, Wako-shi (JP)

(21) Appl. No.: 19/382,514

(22) Filed: Nov. 7, 2025

(30) Foreign Application Priority Data
Nov. 15, 2024 (JP) 2024-199992

(51) Int. Cl. B60W 50/16; B60K 35/28; B60W 40/08; B60W 50/14

(52) U.S. Cl. CPC B60W 50/16; B60K 35/28; B60W 40/08; B60K 2360/741; B60W 2050/146; B60W 2540/223

(57) ABSTRACT

An interface apparatus includes: a user state recognition unit that recognizes a state of a user having boarded a mobile body; a response output control unit that controls an output mode of a notification to be output by a first output apparatus used in the mobile body, according to the state of the user recognized by the user state recognition unit; and an operation recognition notification unit that executes operation recognition notification processing of outputting, by a second output apparatus used in the mobile body, an operation recognition notification when a predetermined operation of the user is recognized by the user state recognition unit, an output mode of the operation recognition notification being changed in conjunction with the predetermined operation.

### INCORPORATION BY REFERENCE

The present application claims priority under 35 U.S.C. § 119 to Japanese Patent Application No. 2024-199992 filed on Nov. 15, 2024. The content of the application is incorporated herein by reference in its entirety.

### BACKGROUND OF THE INVENTION

### Field of the Invention

The present invention relates to an interface apparatus, an interface method, and a storage medium.

### Description of the Related Art

Technology is conventionally known for detecting a line of sight direction of an occupant in a vehicle and adjusting a sound localization position of audio output inside the vehicle so that the sound localization position aligns with the line of sight direction (for example, see Japanese Patent Laid-Open No. 2024-7600). A technology is known for detecting a facial orientation of a driver, determining a sound imaging direction for causing the driver to face towards an area in front of the vehicle, and causing an audio output part to output audio based on a frequency of a direction determination bandwidth corresponding to the determined sound imaging direction (for example, see Japanese Patent Laid-Open No. 2024-20978).

However, when providing a user having boarded a mobile body such as a vehicle with an interactive human machine interface (HMI), it is conceivable to recognize a state of the user such as a line of sight or facial orientation thereof and set a mode of response speech according to the state of the user, as described above in the Description of the Related Art. However, when the user does not recognize that the HMI is responding due to such a function, there is a risk that the user is made to feel uneasy about or distrustful of the HMI, since the user cannot know based on which information the HMI is responding.

Therefore, an object of the present application is to provide an interface apparatus that can reduce causing a user to feel uneasy or distrustful, when performing interactive response processing with the user having boarded a mobile body. The above technique contributes to further improving traffic safety and development of a sustainable transportation system.

### SUMMARY OF THE INVENTION

As a first aspect to achieve the above object, an interface apparatus includes: a user state recognition unit that recognizes a state of a user having boarded a mobile body; a response output control unit that controls an output mode of a notification to be output by a first output apparatus used in the mobile body, according to the state of the user recognized by the user state recognition unit; and an operation recognition notification unit that executes operation recognition notification processing of outputting, by a second output apparatus used in the mobile body, an operation recognition notification when a predetermined operation of the user is recognized by the user state recognition unit, an output mode of the operation recognition notification being changed in conjunction with the predetermined operation.

In the above interface apparatus, the operation recognition notification unit may modify the output mode of the operation recognition notification from the second output apparatus, according to a recognition degree by the user state recognition unit of the predetermined operation.

In the above interface apparatus, the second output apparatus may be a display apparatus, and the operation recognition notification unit may perform output causing the display apparatus to flash as the operation recognition notification, when blinking of the user is recognized by the user state recognition unit as the predetermined operation.

In the above interface apparatus, the second output apparatus may be a seat vibration apparatus that vibrates at a plurality of locations of a seat in which the user sits, and the operation recognition notification unit may perform notification of causing, as the operation recognition notification, the location corresponding to a direction of displacement of a body of the user to vibrate, when displacement of the body of the user is recognized by the user state recognition unit as the predetermined operation.

The above interface apparatus may further include a boarding recognition unit that recognizes that the user boards the mobile body, wherein the operation recognition notification unit may execute the operation recognition notification processing, when the user boarding the mobile body is recognized by the boarding recognition unit.

As a second aspect to achieve the above object, an interface method executed by a computer includes: a user state recognition step of recognizing a state of a user having boarded a mobile body; a response output control step of controlling an output mode of a notification to be output by a first output apparatus used in the mobile body, according to the state of the user recognized in the user state recognition step; and an operation recognition notification step of executing operation recognition notification processing of outputting, by a second output apparatus used in the mobile body, an operation recognition notification when a predetermined operation of the user is recognized in the user state recognition step, an output mode of the operation recognition notification being changed in conjunction with the predetermined operation.

As a third aspect to achieve the above object, a non-transitory computer-readable storage medium storing a program causes a computer to function as: a user state recognition unit that recognizes a state of a user having boarded a mobile body; a response output control unit that controls an output mode of a notification to be output by a first output apparatus used in the mobile body, according to the state of the user recognized by the user state recognition unit; and an operation recognition notification unit that executes operation recognition notification processing of outputting, by a second output apparatus used in the mobile body, an operation recognition notification when a predetermined operation of the user is recognized by the user state recognition unit, an output mode of the operation recognition notification being changed in conjunction with the predetermined operation.

According to the interface apparatus, the interface method, and the storage medium described above, it is possible to reduce causing the user to feel uneasy or distrustful when performing interactive response processing.

### BRIEF DESCRIPTION OF THE DRAWINGS

FIG. 1 is an explanatory diagram of a use mode of an interface apparatus;

FIG. 2 is a configuration diagram of the interface apparatus; and

FIG. 3 is a flowchart of control processing of an output mode of an agent.

### DETAILED DESCRIPTION OF THE INVENTION

### 1. Use Mode of Interface Apparatus

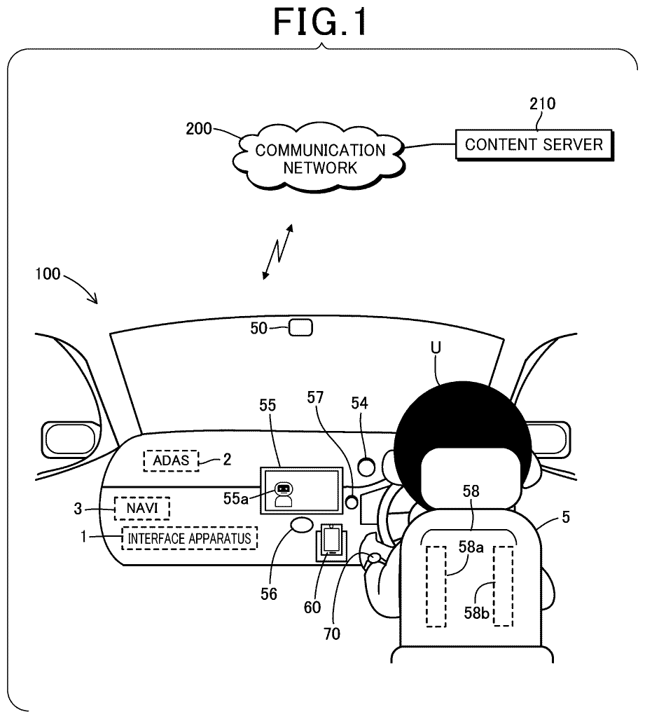

A use mode of an interface apparatus 1 according to the present embodiment will be described with reference to FIG. 1. The interface apparatus 1 provides a user U being a driver of a vehicle 100 with a human machine interface (HMI) using an agent with anthropomorphic emotions. The interface apparatus 1 may be configured as part of functions of an in-vehicle device such as a navigation apparatus installed in the vehicle 100, or may be configured as a dedicated in-vehicle device. The vehicle 100 corresponds to a mobile body of the present disclosure.

The interface apparatus 1 has a communication function, and performs wireless communication between a wearable device 70 (smartwatch or the like) worn by the user U and a mobile terminal 60 (smartphone, tablet terminal, mobile phone, or the like) brought into the vehicle 100 by the user U. The interface apparatus 1 performs communication with a vehicle-exterior communication system, such as a content server 210, via a communication network 200.

The vehicle 100 includes a driver monitor camera 54 that captures the user U, a touch panel display 55, a speaker 56, a microphone 57 that collects an utterance of the user U, a seat vibration apparatus 58 that is attached to a backrest of a driver seat 5 (corresponds to a seat of the present disclosure), a front camera 50 that captures an area in front of the vehicle 100, an advanced driver-assistance system (ADAS) 2 that performs various driving assistance control based on an image captured by the front camera 50, and a navigation apparatus 3 that is configured by a computer and that performs route guidance to a destination. The seat vibration apparatus 58 includes vibration parts 58a and 58b that are disposed in parallel at a plurality of locations in a left-right direction of the backrest of the driver seat 5 (width direction of the vehicle 100). Note that a head-up display (HUD) that projects an image onto a windshield of the vehicle 100 may be provided as an image display apparatus.

The display 55 and a speaker included in the vehicle 100 such as the speaker 56 correspond to a first output apparatus and a second output apparatus of the present disclosure. The seat vibration apparatus 58 corresponds to the second output apparatus of the present disclosure.

The agent installed in the interface apparatus 1 is, for example, an interface agent including an artificial intelligence (AI) program. The agent is an interactive interface that analyzes the speech of the user U input to the microphone 57 through speech recognition, and outputs information through audio output from the speaker 56 or through image display on the display 55 according to utterance content. The agent, depending on an utterance of the user U, suggests a destination via the route guidance of the navigation apparatus 3, suggests content to be downloaded from the content server 210 and played, and performs output of a warning and the like about a predetermined risk (approaching obstacle or the like) recognized by the ADAS 2.

The interface apparatus 1 recognizes a state of the user U based on the image of the user U captured by the driver monitor camera 54, the speech of the user U input to the microphone 57, and the biological information (heart rate, body temperature, blood pressure, and the like) of the user U detected by the wearable device 70. The interface apparatus 1 performs control of setting an output mode by the agent according to the state of the user U.

As will be described in detail below, the interface apparatus 1 executes operation recognition notification processing of notifying the user U that an operation of the user U is recognized by the interface apparatus 1.

### 2. Configuration of Interface Apparatus

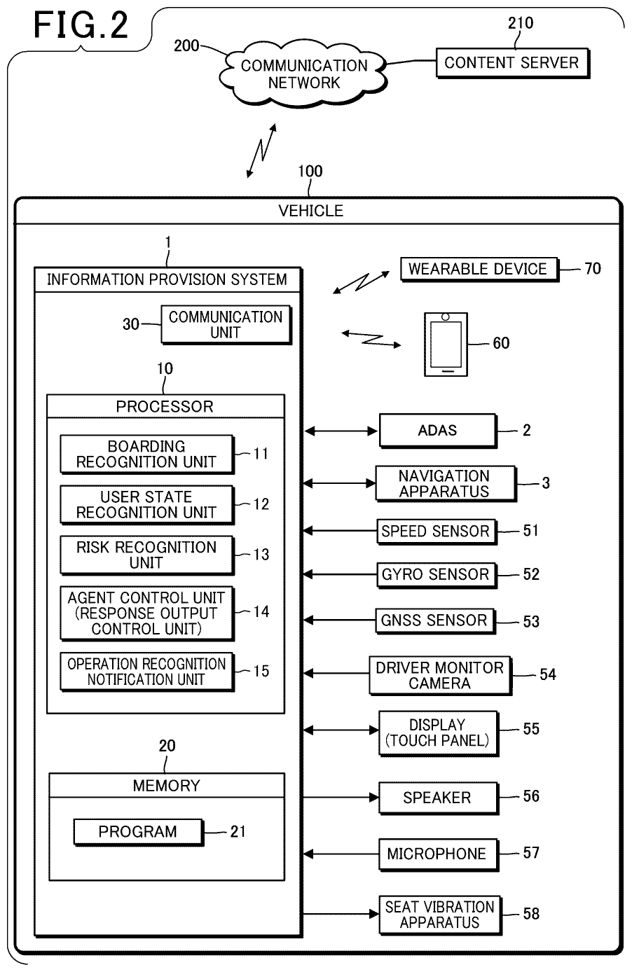

A configuration of the interface apparatus 1 will be described with reference to FIG. 2. The interface apparatus 1 is a control unit including a processor 10, a memory 20, a communication unit 30, and the like. The interface apparatus 1 is connected to the ADAS 2, a speed sensor 51, a gyro sensor 52, a global navigation satellite system (GNSS) sensor 53, the driver monitor camera 54, the display 55, the speaker 56, the microphone 57, and the seat vibration apparatus 58 installed in the vehicle 100.

The communication unit 30 includes a transmitter and a receiver and performs short-range wireless communication between the mobile terminal 60 and the wearable device 70 in accordance with a specification such as Bluetooth (registered trademark) or ultra wideband (UWB). The communication unit 30 performs communication with the content server 210 and the like via the communication network 200.

The memory 20 stores a program 21 for control of the interface apparatus 1, and the like. The processor 10 functions as a boarding recognition unit 11, a user state recognition unit 12, a risk recognition unit 13, an agent control unit 14, and an operation recognition notification unit 15, by loading and executing the program 21. A configuration in which the agent control unit 14 controls an output mode of the notification by the display 55 or the speaker 56 corresponds to a response output control unit of the present disclosure.

Processing executed by the user state recognition unit 12 corresponds to a user state recognition step in an interface method of the present disclosure, and control processing of the output mode of the notification executed by the agent control unit 14 corresponds to a response output control step in the interface method of the present disclosure. Processing executed by the operation recognition notification unit 15 corresponds to an operation recognition notification step in the interface method of the present disclosure.

The boarding recognition unit 11 recognizes that the user U has gotten in (boarded) the vehicle 100 based on turning on a power switch included in the vehicle 100, recognizing the user U through the image captured by the driver monitor camera 54, and the like. The user state recognition unit 12 recognizes, as the state of the user U having gotten in the vehicle 100, the state of the user U based on at least one of information input through a touch operation on the display 55, the image of the user U captured by the driver monitor camera 54, the speech of the user U input to the microphone 57, or the biological information of the user U detected by the wearable device 70.

The user state recognition unit 12 recognizes, for example, the following elements as the state of the user U.

First element: response to an inquiry “How are you feeling today?” or the like displayed on the display 55 when the user U gets in the vehicle 100, the response being input via a touch operation on the display 55.

Second element: expression and behavior of the user U recognized from the image of the user U.

Third element: utterance content, intonation, pitch, and sound volume of the speech of the user U.

Fourth element: biological information of the user U (heart rate, blood pressure, body temperature, and the like).

The risk recognition unit 13 recognizes the predetermined risk faced by the vehicle 100 based on risk information input from the ADAS 2. An example of the predetermined risk faced by the vehicle 100 includes, for example, an approaching monitoring target (other vehicle, pedestrian, obstacle, or the like) present in a vicinity of the vehicle 100. As a distance between the vehicle 100 and the monitoring target decreases, a degree of the risk recognized by the risk recognition unit 13 increases. Note that the risk recognition unit 13 may recognize a degree of concentration of the user U on driving from a facial image of the user U captured by the driver monitor camera 54, the biological information of the user U detected by the wearable device 70, and the like, and may recognize a state in which the degree of concentration has decreased to or below a predetermined level as the predetermined risk.

The risk degree recognition unit 15 may calculate the distance to the monitoring target present in the vicinity of the vehicle 100 by using communication by an inter-vehicle communication apparatus, a GNSS unit, V2X (communication between road and vehicle or between pedestrians, and the like), or the like, thereby calculating the degree of the risk.

The agent control unit 14 provides the user U with the HMI via the agent with anthropomorphic emotions. The agent control unit 14 analyzes the utterance of the user U input to the microphone 57, and outputs a response to the utterance by outputting the speech of the agent from the speaker 56 or through the image display of the agent on the display 55. The agent control unit 14 performs notification for encouraging alertness when the predetermined risk is recognized by the risk recognition unit 13, by outputting the warning speech from the speaker 56 and displaying a warning image on the display 55. The agent control unit 14 controls the output mode of the speech (intonation, pitch, sound volume, and the like) of the agent output from the speaker 56, and a display mode of an image (movement, display position, size, and the like) of the agent shown on the display 55, according to the state of the user U recognized by the user state recognition unit 12.

The operation recognition notification unit 15 executes the operation recognition notification processing of notifying the user U that the operation of the user U is recognized by the interface apparatus 1, when it is recognized by the boarding recognition unit 11 that the user U gets in the vehicle 100. The operation recognition notification unit 15 performs, in the operation recognition notification processing, operation confirmation notification according to, for example, the following first to fourth notification examples, based on the image captured by the driver monitor camera 54.

First notification example: the operation recognition notification unit 15 performs, as the operation confirmation notification, operation confirmation notification of displaying an image on the display 55 (for example, an image 55a of the agent shown in FIG. 1) matching a direction of the line of sight of the user U, when recognizing a change in the direction of the line of sight of the user U from the image captured by the driver monitor camera 54. The operation recognition notification unit 15, for example, displays the image 55a on a left side of the display 55 when the line of sight of the user U is directed to the left, and displays the image 55a on a right side of the display 55 when the line of sight is directed to the right. The change in the direction of the line of sight of the user U corresponds to a predetermined operation of the user of the present disclosure, a change degree of the direction of the line of sight corresponds to a recognition degree of the predetermined operation of the present disclosure, and a change in where the image 55a is displayed corresponds to an output mode of the operation confirmation notification of the present disclosure. Note that when the HUD is provided, a position of the image projected onto the windshield by the HUD may be changed to match the direction of the line of sight of the user U.

Second notification example: the operation recognition notification unit 15 causes, as the operation confirmation notification, a screen display of the display 55 to flash, when recognizing that the user U blinks from the image captured by the driver monitor camera. In this case, an interval at which the screen display of the display 55 is caused to flash may be shortened as the blinking is faster, depending on a speed of the blinking of the user U. The blinking of the user U corresponds to the predetermined operation of the user of the present disclosure, the speed of the blinking corresponds to the recognition degree of the predetermined action of the present disclosure, and the flashing interval of the screen display of the display 55 corresponds to the output mode of the operation confirmation notification of the present disclosure.

Third notification example: the operation recognition notification unit 15 performs operation confirmation notification of outputting notification speech, matching a sound image position to a direction of the face of the user U, from a plurality of speakers included in the vehicle 100 (may include the speaker 56) according to the direction of the face of the user U, when recognizing a change in the direction of the face (direction of head) of the user U from the image captured by the driver monitor camera. The operation recognition notification unit 15, for instance, sets the sound image position to the left of the user U and outputs the notification speech when the user U faces the left side, and sets the sound image position to the right of the user U and outputs the warning speech when the user U faces the right side. In this case, the sound volume of the notification speech may be increased the greater the change in the direction of the face of the user U. The operation of changing the direction of the face of the user U corresponds to the predetermined operation of the user of the present disclosure, a magnitude of the change in the direction of the face corresponds to the recognition degree of the predetermined operation of the present disclosure, and a magnitude of the notification speech corresponds to the output mode of the operation confirmation notification of the present disclosure.

Fourth notification example: the operation recognition notification unit 15 performs operation confirmation notification of causing a vibration part among the vibration parts 58a and 58b of the seat vibration apparatus 58 that is closest to a center of gravity of the user U to vibrate, when recognizing displacement of the body (displacement of head, torso, arm, hand, and the like) of the user U from the image captured by the driver monitor camera. For example, since the center of gravity of the user U is displaced to the left when the user U tilts their head to the left, the operation recognition notification unit 15 causes the left-side vibration part 58a to vibrate. Since the center of gravity of the user U is displaced to the right when the user U tilts their head to the right, the operation recognition notification unit 15 causes the right-side vibration part 58b to vibrate. In this case, the vibration of the vibration parts 58a and 58b may be increased the greater the displacement of the body of the user U, according to a magnitude of the displacement of the body of the user U. The displacement of the body of the user U corresponds to the predetermined operation of the user of the present disclosure, the magnitude of the displacement of the body corresponds to the recognition degree of the predetermined operation of the present disclosure, and the magnitude of the vibration of the vibration parts 58a and 58b corresponds to the output mode of the operation confirmation notification of the present disclosure.

### 3. Control Processing of Output Mode of Agent

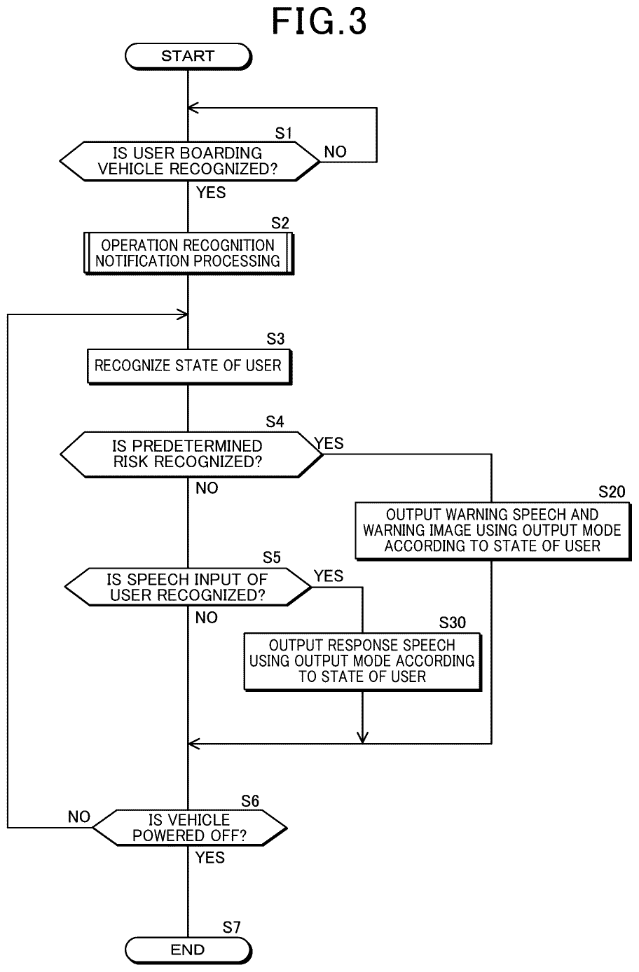

A procedure of the control processing of the output mode of the HMI agent executed by the interface apparatus 1 will be described according to a flowchart shown in FIG. 3.

In step S1 of FIG. 3, the boarding recognition unit 11 proceeds the processing to step S2 when recognizing that the user U gets in the vehicle 100. In step S2, the operation recognition notification unit 15 executes the above-described operation confirmation notification processing. In this way, it is possible to inform the user U, who is about to start driving the vehicle 100, in advance that the state of the user is recognized by the interface apparatus 1, by executing the operation confirmation notification processing when the user U gets in the vehicle 100. With this, it is possible to reduce causing the user U to feel uneasy about or distrustful of notification output and the like by the agent, since the user U can recognize that the notification output and the like by the agent of the interface apparatus 1 is being performed based on a recognition result of the state of the user U.

Next, in step S3, the user state recognition unit 12 recognizes the state of the user U as described above. Next, in step S4, the risk recognition unit 13 proceeds the processing to step S20 when the predetermined risk is recognized, and proceeds the processing to step S5 when the predetermined risk is not recognized. In step S20, the agent control unit 14 outputs the warning speech and the warning image corresponding to the predetermined risk recognized by the risk recognition unit 13 using an output mode according to the state of the user U, respectively through the speaker 56 and the display 55, and then proceeds the processing to step S6.

In step S5, the agent control unit 14 proceeds the processing to step S30 when the speech of the user U input to the microphone 57 is recognized, and proceeds the processing to step S6 when the speech of the user U input to the microphone 57 is not recognized. In step S30, the agent control unit 14 outputs response speech with respect to input speech of the user U using the output mode corresponding to the state of the user U. For example, when the input speech of the user U indicates a request for playback of lively music, the agent control unit 14 outputs the title of the music extracted as a playback candidate from the speaker 56 with a bright and cheerful voice, and then proceeds the processing to step S6.

In step S6, the agent control unit 14 determines whether the vehicle 100 has been powered off. When the vehicle 100 has not been powered off, the agent control unit 14 then proceeds the processing to step S3 and executes the processing in steps S3 to S6, S20, and S30 again. On the other hand, when the vehicle 100 has been powered off, the agent control unit 14 proceeds the processing to step S7 and ends the control processing of the output mode of the agent.

### 4. Other Embodiments

In the above embodiment, the vehicle 100 is shown as the mobile body of the present disclosure, but the mobile body of the present disclosure may be an aircraft, a ship, or the like as long as an interface is used for the user having gotten in the vehicle 100.

In the above embodiment, the interface apparatus of the present disclosure is exemplified as the interface apparatus 1 configured as an in-vehicle device installed in the vehicle 100. As another embodiment, part or all of the interface apparatus of the present disclosure may be configured as the mobile terminal 60 brought into the vehicle 100, or as an external communication system such as the content server 210 outside of the vehicle 100.

When configuring the interface apparatus as the mobile terminal 60, it is possible to provide the HMI utilizing the agent by using a camera, a microphone, a speaker, and a display included in the mobile terminal 60. The biological information of the user U may be obtained through communication between the wearable device 70 and the mobile terminal 60, and the state of the user U may be recognized by the mobile terminal 60 based on the biological information. The output of the display 55, a speaker included in the vehicle 100 such as the speaker 56, and the seat vibration apparatus 58 may be controlled by the mobile terminal 60 through the communication between the in-vehicle device of the vehicle 100 and the mobile terminal 60.

When configuring the interface apparatus as an external communication system, for example, the image of the user U captured by the driver monitor camera 54 of the vehicle 100, speech data input to the microphone 57, and the like are transmitted from the vehicle 100 to the external communication system, the state of the user U is recognized by the external communication system, and the operation confirmation notification processing is executed.

In the above embodiment, the boarding recognition unit 11 is provided, and the operation recognition notification unit 15 executes the operation confirmation notification processing when the boarding recognition unit 11 recognizes that the user U gets in the vehicle 100. As another embodiment, the operation confirmation notification processing may be executed at a different timing, for example, every time a predetermined amount of time elapses time period while the user U is in the vehicle 100. When executing the operation recognition notification processing, speech output, screen display, or the like may be performed to encourage the user U to perform a predetermined operation, such as “please blink” or “please move your head.”

Note that FIG. 2 is a schematic diagram showing the configuration of the interface apparatus 1 by dividing the configuration according to a main processing content to facilitate understanding of the invention of the present application, and the configuration of the interface apparatus 1 may be divided differently. The processing of respective components may be executed by one hardware unit or may be executed by a plurality of hardware units. The processing of each component shown in FIG. 3 may be executed by one program or may be executed by a plurality of programs.

### 5. Configurations Supported by Above Embodiments

The above embodiments are specific examples of the following configurations.

### Configuration 1

An interface apparatus including: a user state recognition unit that recognizes a state of a user having boarded a mobile body; a response output control unit that controls an output mode of a notification to be output by a first output apparatus used in the mobile body, according to the state of the user recognized by the user state recognition unit; and an operation recognition notification unit that executes operation recognition notification processing of outputting, by a second output apparatus used in the mobile body, an operation recognition notification when a predetermined operation of the user is recognized by the user state recognition unit, an output mode of the operation recognition notification being changed in conjunction with the predetermined operation.

According to the interface apparatus of Configuration 1, it is possible to reduce causing the user to feel uneasy or distrustful when performing interactive response processing, since it is possible to inform the user having boarded the mobile body that the operation of the user is recognized by the interface apparatus, through the output of the operation confirmation notification by the second output apparatus.

### Configuration 2

The interface apparatus according to Configuration 1, wherein the operation recognition notification unit modifies the output mode of the operation recognition notification from the second output apparatus, according to a recognition degree by the user state recognition unit of the predetermined operation.

According to the interface apparatus of Configuration 2, the user can easily confirm that the user is recognized by the interface apparatus, since the output mode of the operation recognition notification by the second output apparatus is modified according to a change in the operation of the user.

### Configuration 3

The interface apparatus according to Configuration 1 or 2, wherein the second output apparatus is a display apparatus, and the operation recognition notification unit performs output causing the display apparatus to flash as the operation recognition notification, when blinking of the user is recognized by the user state recognition unit as the predetermined operation.

According to the interface apparatus of Configuration 3, the user can easily confirm that the user is recognized by the interface apparatus, through the flashing of the display apparatus in conjunction with the blinking of the user.

### Configuration 4

The interface apparatus according to any one of Configurations 1 to 3, wherein the second output apparatus is a seat vibration apparatus that vibrates at a plurality of locations of a seat in which the user sits, and the operation recognition notification unit performs notification of causing, as the operation recognition notification, the location corresponding to a direction of displacement of a body of the user to vibrate, when displacement of the body of the user is recognized by the user state recognition unit as the predetermined operation.

According to the interface apparatus of Configuration 4, the user can easily confirm that the user is recognized by the interface apparatus, through the vibration of the seat at the location corresponding to the direction of the displacement of the body of the user.

### Configuration 5

The interface apparatus according to any one of Configurations 1 to 4, further including a boarding recognition unit that recognizes that the user boards the mobile body, wherein the operation recognition notification unit executes the operation recognition notification processing, when the user boarding the mobile body is recognized by the boarding recognition unit.

According to the interface apparatus of Configuration 5, it is possible to inform the user that the user is recognized by the interface apparatus, when the user boards the mobile body.

### Configuration 6

An interface method executed by a computer, the interface method including: a user state recognition step of recognizing a state of a user having boarded a mobile body; a response output control step of controlling an output mode of a notification to be output by a first output apparatus used in the mobile body, according to the state of the user recognized in the user state recognition step; and an operation recognition notification step of executing operation recognition notification processing of outputting, by a second output apparatus used in the mobile body, an operation recognition notification when a predetermined operation of the user is recognized in the user state recognition step, an output mode of the operation recognition notification being changed in conjunction with the predetermined operation.

It is possible to achieve advantageous effects similar to those of the interface apparatus of Configuration 1 through the computer executing the interface method of Configuration 6.

### Configuration 7

A non-transitory computer-readable storage medium storing a program for causing a computer to function as: a user state recognition unit that recognizes a state of a user having boarded a mobile body; a response output control unit that controls an output mode of a notification to be output by a first output apparatus used in the mobile body, according to the state of the user recognized by the user state recognition unit; and an operation recognition notification unit that executes operation recognition notification processing of outputting, by a second output apparatus used in the mobile body, an operation recognition notification when a predetermined operation of the user is recognized by the user state recognition unit, an output mode of the operation recognition notification being changed in conjunction with the predetermined operation.

It is possible to achieve the configuration of the interface apparatus of Configuration 1 through the computer executing the program of Configuration 7.

### REFERENCE SIGNS LIST

1: interface apparatus
2: ADAS
10: processor
11: boarding recognition unit
12: user state recognition unit
13: risk recognition unit
14: agent control unit (response output control unit)
15: operation recognition notification unit
20: memory
21: program
30: communication unit
50: front camera
51: speed sensor
52: gyro sensor
53: GNSS sensor
54: driver monitor camera
55: display
56: speaker
57: microphone
58: seat vibration apparatus
60: mobile terminal
70: wearable device
100: vehicle (mobile body)
200: communication network
210: content server
U: user

1. An interface apparatus comprising:
a user state recognition unit that recognizes a state of a user having boarded a mobile body;
a response output control unit that controls an output mode of a notification to be output by a first output apparatus used in the mobile body, according to the state of the user recognized by the user state recognition unit; and
an operation recognition notification unit that executes operation recognition notification processing of outputting, by a second output apparatus used in the mobile body, an operation recognition notification when a predetermined operation of the user is recognized by the user state recognition unit, an output mode of the operation recognition notification being changed in conjunction with the predetermined operation.

2. The interface apparatus according to claim 1, wherein the operation recognition notification unit modifies the output mode of the operation recognition notification from the second output apparatus, according to a recognition degree by the user state recognition unit of the predetermined operation.

3. The interface apparatus according to claim 1, wherein
the second output apparatus is a display apparatus, and
the operation recognition notification unit performs output causing the display apparatus to flash as the operation recognition notification, when blinking of the user is recognized by the user state recognition unit as the predetermined operation.

4. The interface apparatus according to claim 1, wherein
the second output apparatus is a seat vibration apparatus that vibrates at a plurality of locations of a seat in which the user sits, and
the operation recognition notification unit performs notification of causing, as the operation recognition notification, the location corresponding to a direction of displacement of a body of the user to vibrate, when displacement of the body of the user is recognized by the user state recognition unit as the predetermined operation.

5. The interface apparatus according to claim 1, further comprising a boarding recognition unit that recognizes that the user boards the mobile body, wherein
the operation recognition notification unit executes the operation recognition notification processing, when the user boarding the mobile body is recognized by the boarding recognition unit.

6. An interface method executed by a computer, the interface method comprising:
a user state recognition step of recognizing a state of a user having boarded a mobile body;
a response output control step of controlling an output mode of a notification to be output by a first output apparatus used in the mobile body, according to the state of the user recognized in the user state recognition step; and
an operation recognition notification step of executing operation recognition notification processing of outputting, by a second output apparatus used in the mobile body, an operation recognition notification when a predetermined operation of the user is recognized in the user state recognition step, an output mode of the operation recognition notification being changed in conjunction with the predetermined operation.

7. A non-transitory computer-readable storage medium storing a program for causing a computer to function as:
a user state recognition unit that recognizes a state of a user having boarded a mobile body;
a response output control unit that controls an output mode of a notification to be output by a first output apparatus used in the mobile body, according to the state of the user recognized by the user state recognition unit; and
an operation recognition notification unit that executes operation recognition notification processing of outputting, by a second output apparatus used in the mobile body, an operation recognition notification when a predetermined operation of the user is recognized by the user state recognition unit, an output mode of the operation recognition notification being changed in conjunction with the predetermined operation.
